(19) United States
(12) Patent Application Publication
(10) Pub. No.: US 2007/0233539 A1
(43) Pub. Date: Oct. 4, 2007

(54) Providing human capital management software application as enterprise services

(76) Inventors: Philipp Suenderhauf, Leimen (DE); Matthias Richter, Sinsheim (DE); Frank Schuhmacher, St. Leon-Rot (DE); Ricardo Bustamante, Kronau (DE); Thomas Moser, Wiesloch (DE); Peter Sieber, Wiesloch (DE); Matthias Tebbe, Walldorf (DE); Horst Vaeth, Mannheim (DE); Silke A. H. Gruber, Sinsheim (DE); Fabian Guenther, Mauer (DE); Marc Moesges, Heidelberg (DE); Volker Paul, Herxheim (DE); Marcus Philipp, DieIheim (DE); Jens Ruths, Wiesloch (DE)

Correspondence Address: FISH & RICHARDSON, P.C., PO BOX 1022, MINNEAPOLIS, MN, 55440-1022, US

(21) Appl. No.: 11/396,236

(22) Filed: Mar. 30, 2006

(51) Int. Cl. G06F 9/46

(52) U.S. Cl. 705/8

(57) ABSTRACT

Methods and apparatus, including systems and computer program products, for a service architecture design that provides enterprise services having human capital management functionality at the level of an enterprise application. The design includes a set of service operations, process components, and optionally deployment units. Suitable business objects are also described.

### BACKGROUND

This specification relates to data processing systems implemented on computers, and more particular to data processing systems providing services in the nature of web services.

Enterprise software systems are generally large and complex. Such systems can require many different components, distributed across many different hardware platforms, possibly in several different geographical locations. Thus, the architecture of a large software application, i.e., what its components are and how they fit together, is an important aspect of its design for a successful implementation.

Web services are one technology for making the functionality of software applications available to other software, including other applications. A web service is a standards-based way of encapsulating the functionality of an application that other applications can locate and access. A service-oriented architecture is a distributed software model within which functionality is defined as independent web services. Within a service-oriented architecture, web services can be used in defined sequences according to business logic to form applications that enable business processes.

### SUMMARY

This specification describes a service architecture design that provides enterprise services having human capital management functionality at the level of an enterprise application. Enterprise services are web services that have an enterprise-level business value.

In its various aspects, the invention can be embodied in systems, methods, and computer program products. For example, a system in one embodiment implements a services architecture design that provides enterprise services having human capital management functionality at the level of an enterprise application. The design includes a set of service operations, process components, and optionally deployment units. Suitable business objects are also described.

The subject matter described in this specification can be implemented to realize one or more of the following advantages. Effective use is made of process components as units of software reuse, to provide a design that can be implemented reliably in a cost effective way. Effective use is made of deployment units, each of which is deployable on a separate computer hardware platform independent of every other deployment unit, to provide a scalable design. Service interfaces of the process components define a pair-wise interaction between pairs of process components that are in different deployment units in a scalable way.

Details of one or more implementations of the subject matter described in this specification are set forth in the accompanying drawings and in the description below. Further features, aspects, and advantages of the subject matter will become apparent from the description, the drawings, and the claims.

### BRIEF DESCRIPTION OF THE DRAWINGS

FIG. 1 illustrates a high-level view of a software architectural design and implementation of a suite enterprise software services having human capital management functionality.

FIG. 2 is a block diagram of a compensation management process component.

FIGS. 3A and 3B are block diagrams collectively showing a time and labor management process component.

FIG. 4 is a block diagram of a personnel administration process component.

Like reference numbers and designations in the various drawings indicate like elements.

### DETAILED DESCRIPTION

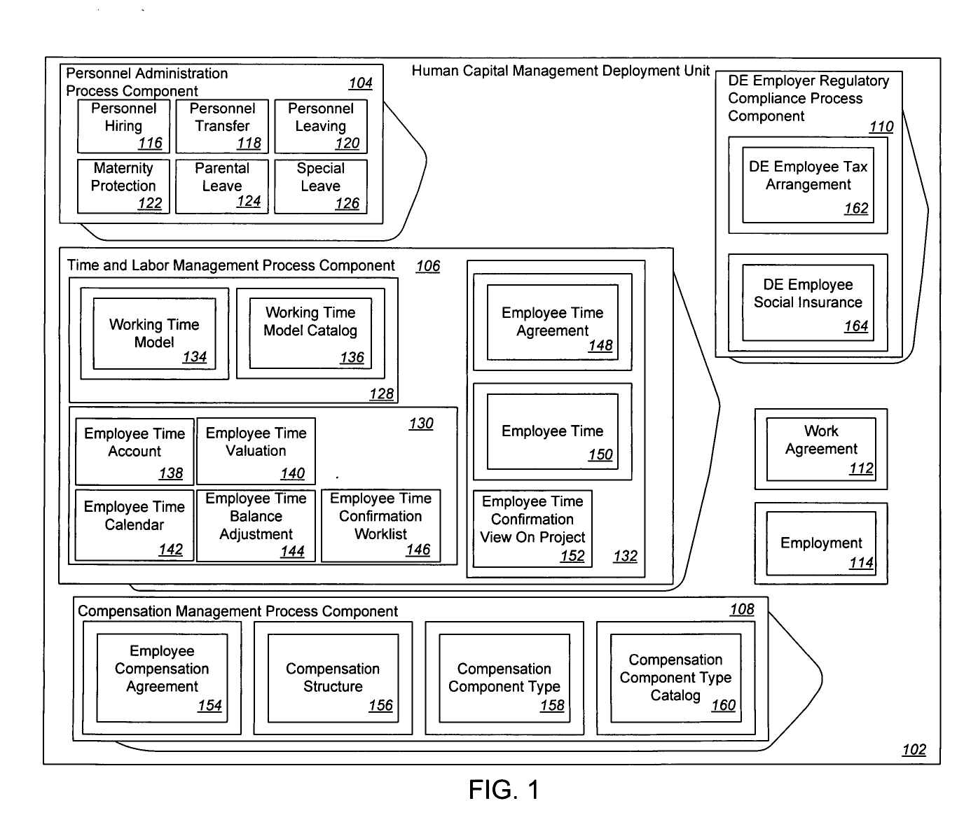

FIG. 1 illustrates a high-level view of a software architectural design, and of application software implementations of the design, that provides a suite of enterprise service operations, which can be organized into interfaces, having human capital management application functionality.

The elements of the architecture include the business object, the process component, the service operation (or simply, the operation), the service interface, the message, and the deployment unit. The elements can also include process agents and reuse service components. These will be generally described below.

In one implementation, the software is implemented to be deployed on an application platform that includes a foundation layer that contains all fundamental entities that can used from multiple deployment units. These entities can be process components, business objects or reuse service components. A reuse service component is a piece of software that is reused in different transactions. A reuse service component is used by its defined interfaces, which can be, e.g., local APIs (Application Programming Interfaces) or service interfaces.

The architectural design is a specification of a computer software application, and elements of the architectural design can be implemented to realize a software application that implements enterprise application service interfaces. The elements of the architecture are at times described in this specification as being contained or included in other elements; for example, a process component is described as being contained in a deployment unit. It should be understood, however, that such operational inclusion can be realized in a variety of ways and is not limited to a physical inclusion of the entirety of one element in another.

The architectural elements include the business object. A business object is a representation of a type of a uniquely identifiable business entity (an object instance) described by a structural model. Processes operate on business objects.

A business object represents a specific view on some well-defined business content. A business object represents content, and instances of business objects include content, which a typical business user would expect and understand with little explanation. Whether an object as a type or an instance of an object is intended by the term is generally clear from the context, so the distinction will be made explicitly only when necessary. Properly implemented, business objects are implemented free of redundancies.

Business objects are further categorized as business process objects and master data objects. A master data object is an object that encapsulates master data (i.e., data that is valid for a period of time). A business process object, which is the kind of business object generally found in a process component, is an object that encapsulates transactional data (i.e., data that is valid for a point in time). A mass data run object is an application object that executes an algorithm for a particular mass data run. An instance of a mass data run object contains a particular set of selections and parameters. A mass data run object implements an algorithm that modifies, manages, and/or processes a large amount of data in multiple transactions, possibly but not necessarily with parallel processing. A dependent object is a business object used as a reuse part in another business object. A dependent object represents a concept that cannot stand by itself from a business point of view. Instances of dependent objects only occur in the context of a non-dependent business object. A transformed object is a transformation of multiple business objects for a well-defined purpose. It transforms the structure of multiple business objects into a common structure. A transformed object does not have its own persistency.

The architectural elements also include the process component. A process component is a software package that realizes a business process and generally exposes its functionality as services. The functionality contains business transactions. A process component contains one or more semantically related business objects. Any business object belongs to no more than one process component.

Process components are modular and context-independent. That they are context-independent means that a process component is not specific to any specific application and is reusable. The process component is the smallest (most granular) element of reuse in the architecture.

The architectural elements also include the operation. An operation belongs to exactly one process component. A process component generally has multiple operations. Operations can be synchronous or asynchronous, corresponding to synchronous or asynchronous process agents, which will be described below. An operation is the smallest, separately-callable function, described by a set of data types used as input, output, and fault parameters, or some combination of them, serving as a signature. For convenience in supporting use of the operations supported by a system implementing elements of the design such a system can optionally include a repository of service descriptions that includes a standards-based description of each of the supported service operations.

The architectural elements also include the service interface, which may be referred to simply as an interface. An interface is a named group of operations. Each operation belongs to exactly one interface. An interface belongs to exactly one process component. A process component might contain multiple interfaces. In one implementation, an interface contains only inbound or outbound operations, but not a mixture of both. One interface can contain both synchronous and asynchronous operations. All operations of the same type (either inbound or outbound) which belong to the same message choreography will preferably belong to the same interface. Thus, generally, all outbound operations to the same other process component are in one interface.

The architectural elements also include the message. Operations transmit and receive messages. Any convenient messaging infrastructure can be used. A message is information conveyed from one process component instance to another, with the expectation that activity will ensue. An operation can use multiple message types for inbound, outbound, or error messages. When two process components are in different deployment units, invocation of an operation of one process component by the other process component is accomplished by an operation on the other process component sending a message to the first process component.

The architectural elements also include the process agent. Process agents do business processing that involves the sending or receiving of messages. Each operation will generally have at least one associated process agent. A process agent can be associated with one or more operations. Process agents can be either inbound or outbound, and either synchronous or asynchronous.

Asynchronous outbound process agents are called after a business object changes, e.g., after a create, update, or delete of a business object instance.

Synchronous outbound process agents are generally triggered directly by a business object.

An output process agent will generally perform some processing of the data of the business object instance whose change triggered the event. An outbound agent triggers subsequent business process steps by sending messages using well-defined outbound services to another process component, which generally will be in another deployment unit, or to an external system. An outbound process agent is linked to the one business object that triggers the agent, but it is sent not to another business object but rather to another process component. Thus, the outbound process agent can be implemented without knowledge of the exact business object design of the recipient process component.

Inbound process agents are called after a message has been received. Inbound process agents are used for the inbound part of a message-based communication. An inbound process agent starts the execution of the business process step requested in a message by creating or updating one or multiple business object instances. An inbound process agent is not the agent of a business object but of its process component. An inbound process agent can act on multiple business objects in a process component.

Synchronous agents are used when a process component requires a more or less immediate response from another process component, and is waiting for that response to continue its work.

Operations and process components are described in this specification in terms of process agents. However, in alternative implementations, process components and operations can be implemented without use of agents using other conventional techniques to perform the functions described in this specification.

The architectural elements also include the deployment unit. A deployment unit includes one or more process components and, optionally, one or more business objects, that are deployed together on a single computer system platform. Conversely, separate deployment units can be deployed on separate physical computing systems. For this reason, a deployment unit boundary defines the limits of an application-defined transaction, i.e., a set of actions that have the ACID properties of atomicity, consistency, isolation, and durability. To make use of database manager facilities, the architecture requires that all operations of such a transaction be performed on one physical database; as a consequence, the processes of such a transaction must be performed by the process components of one instance of one deployment unit.

The process components of one deployment unit interact with those of another deployment unit using messages passed through one or more data communication networks or other suitable communication channels. Thus, a deployment unit deployed on a platform belonging one business can interact with a deployment unit software entity deployed on a separate platform belonging to a different and unrelated business, allowing for business-to-business communication. More than one instance of a given deployment unit can execute at the same time, on the same computing system or on separate physical computing systems. This arrangement allows the functionality offered by a deployment unit to be scaled to meet demand by creating as many instances as needed.

Since interaction between deployment units is through service operations, a deployment unit can be replaced by other another deployment unit as long as the new deployment unit supports the operations depended upon by other deployment units. Thus, while deployment units can depend on the external interfaces of process components in other deployment units, deployment units are not dependent on process component interactions (i.e., interactions between process components involving their respective business objects, operations, interfaces, and messages) within other deployment units. Similarly, process components that interact with other process components or external systems only through messages, e.g., as sent and received by operations, can also be replaced as long as the replacement supports the operations of the original.

Interactions between process components that occur only within a deployment unit are not constrained to using service operations. These can be implemented in any convenient fashion.

In contrast to a deployment unit, the foundation layer does not define a limit for application-defined transactions. Deployment units communicate directly with entities in the foundation layer, which communication is typically not message based. The foundation layer is active in every system instance on which the application is deployed. Business objects in the foundation layer will generally be master data objects. In addition, the foundation layer will include some business process objects that are used by multiple deployment units. Master data objects and business process objects that should be specific to a deployment unit are preferably assigned to their respective deployment unit.

FIG. 1 illustrates a high-level view of a software architectural design and implementation of a suite enterprise software services having human capital management functionality.

As shown in FIG. 1, a Human Capital Management deployment unit 102 includes a Personnel Administration process component 104, a Time and Labor Management process component 106, a Compensation Management process component 108, a DE Employer Regulatory Compliance process component 110, a Work Agreement master data object 112, and an Employment master data object 114.

The Personnel Administration process component 102 includes a Personnel Hiring business object 116, a Personnel Transfer business object 118, a Personnel Leaving business object 120, a Maternity Protection business object 122, a Parental Leave business object 124, and a Special Leave business object 126.

The Time and Labor Management process component 106 includes a Time Models process implementation package 128, a Time Accounts process implementation package 130, and a Time Recording process implementation package 132. The Time Models process implementation package 128 includes a Working Time Model master data object 134 and a Working Time Model Catalog master data object 136. The Time Accounts process implementation package includes five business objects: an Employee Time Account business object 138, an Employee Time Valuation business object 140, an Employee Time Calendar business object 142, an Employee Time balance Adjustment business object 144, and an Employee Time Confirmation Worklist business object 146. The Time Recording process implementation package includes an Employee Time Agreement master data object 148, an Employee Time master data object 150, and an Employee Time Confirmation View On Project business object 152.

As shown in FIG. 1, the Compensation Management process component 108 includes an Employee Compensation Agreement master data object 154, a Compensation Structure master data object 156, a Compensation Component Type master data object 158, and a Compensation Component Type Catalog master data object 160.

The DE Employer Regulatory Compliance Process Component 110 includes a DE Employee Tax Arrangement master data object 162 and a DE Employee Social Insurance master data object 164. The DE Employer Regulatory Compliance process component 110 combines all activities an employer in Germany is obliged to perform with respect to employees. It includes data management and communication with authorities and other bodies concerning taxes and social insurance. The DE Employee Tax Arrangement master data object 162 defines parameters that are needed for calculation and reporting of income tax deductions for an employee according to German legal requirements. It contains parameters recorded from the tax card supplied to the employee (e.g. tax authority, tax class, and number of child tax exemptions), supplementary details (e.g. tax table to be used, and special rules) and details from previous employments in the current tax year that are relevant for year-to-date amounts. The DE Employee Social Insurance master data object 164 defines parameters that are needed for calculation of German social insurance contributions and reporting for an employee according to the German data recording and transfer ordinance. It contains parameters required for the different types of social insurance contributions (e.g. health insurance, pension insurance, unemployment insurance and nursing insurance) to various public and private insurance bodies. For example, these bodies may include state health insurance funds, private insurance providers and the German pension insurance federation.

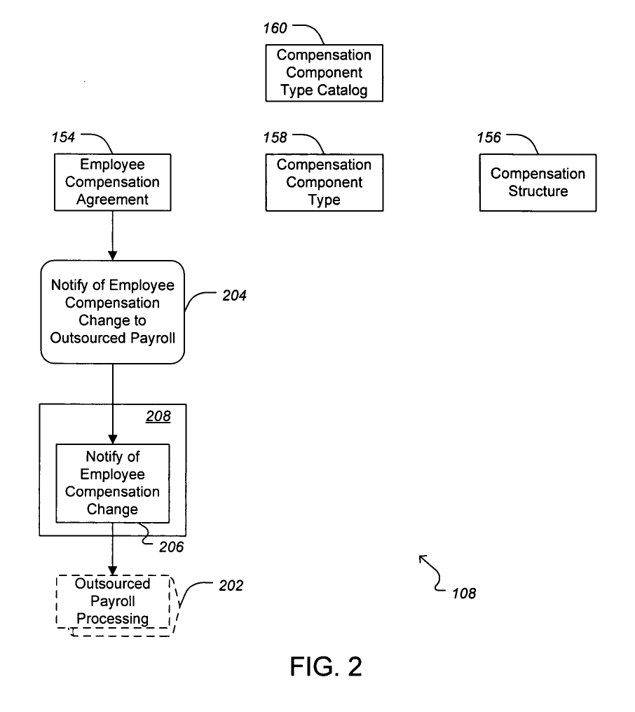

FIG. 2 is a block diagram of a Compensation Management process component 108 (FIG. 1). The Compensation Management process component 108 provides the ability to plan and to set up remuneration data for individual employees based on reward strategies, including performance-based and competency-based pay, variable pay plans, bonuses and long-term incentives. It supports companies in defining and putting into practice compensation structures throughout their lines of business. An Outsourced Payroll Processing process component 202, which is not part of the process component being described, is included for convenience in describing this process component. The Outsourced Payroll Processing process component 202 is used to represent software external to the process component in describing its interactions with the external software; however, while the external software can be implemented as such process components, this is not required.

The Compensation Management process component 108 includes the Employee Compensation Agreement master data object 154 that is an agreement between an employer and an employee detailing all compensation components that are relevant to the employee, such as base salary, one-time and recurring payments and payments for employee benefits. Additionally, part of the agreement can be an assignment of a compensation structure which shall be valid for the employee. An update in the Employee Compensation Agreement master data object 154 triggers a Notify of Employee Compensation Change to Outsourced Payroll outbound process agent 204 to invoke a Notify of Employee Compensation Change operation 206 in a Payroll Out interface 208. The Notify of Employee Compensation Change operation 206 then sends a notification about the changes in the employee compensation to the Outsourced Payroll Processing process component 202.

The Compensation Management process component 108 also includes the Compensation Structure master data object 156, the Compensation Component Type master data object 158, and the Compensation Component Type Catalog master data object 160. The Compensation Structure master data object 156 consists of compensation grades which can be subdivided into compensation levels. A compensation grade or level, respectively, defines the quality rating and criteria which an employee has to meet with respect to his functions and tasks within the company such that he classifies for the corresponding grade or level. The Compensation Structure master data object 156 is either company-specific or provided via a collective labor agreement. The Compensation Component Type master data object 158 divides up compensation components according to their meaning in human resources. The Compensation Component Type Catalog master data object 160 is a structured directory of the Compensation Component Type master data objects 158. Nodes of this catalog are groups of the Compensation Component Type master data objects 158 which are belonging together semantically.

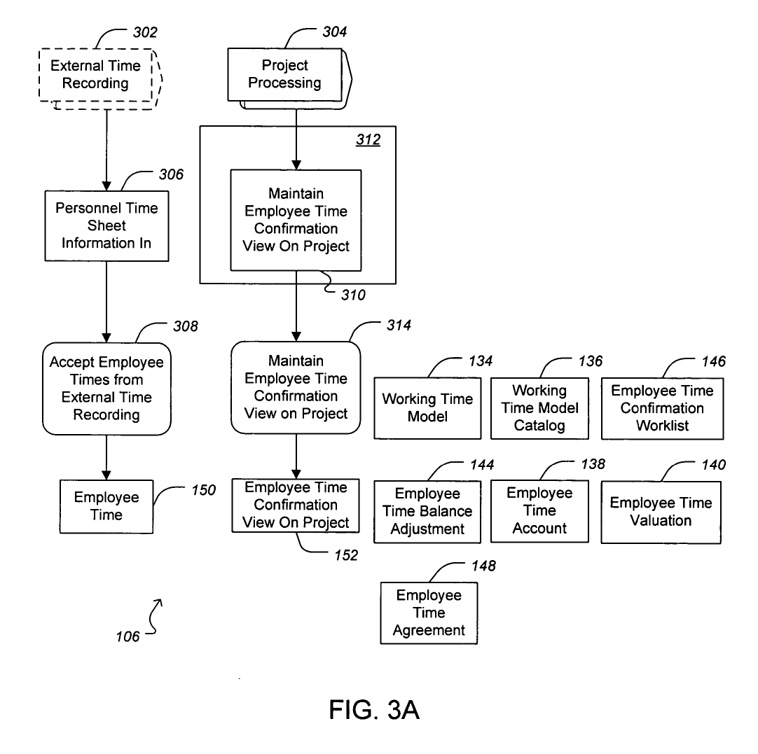

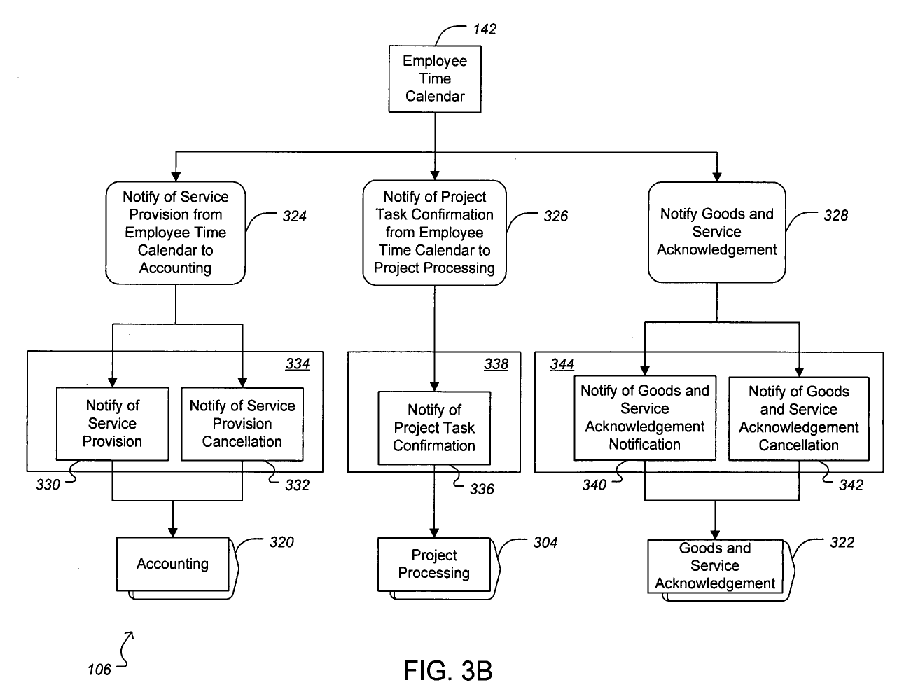

FIGS. 3A-3B are block diagrams collectively showing the Time and Labor Management process component 106 (FIG. 1). The Time and Labor Management process component 106 supports the definition of employees' planned working time as well as the recording of the actual working times and absences and their evaluation. As shown in FIG. 3A, an External Time Recording process component 302 is used to represent software external to the process component in describing its interactions with the external software and a Project Process component 304 are included to show an exemplary output source. These process components are not required.

The Employee Time master data object 150 concerns the planned and recorded working times of an employee, and various views of these documents, such as information about the employee's availability. Absence times, break times, and on-call availability times are also documented along with working times and activities for the company. Depending on the business process in which the employee times are to be used or processed further, they are assigned additional information, such as that required for controlling, confirmations for projects or orders, invoicing, and for payroll. As an example, the External Time Recording process component 302 may send information, such as updates on time information, to a Personnel Time Sheet Information In operation 306. The Personnel Time Sheet Information In operation 306 then triggers an Accept Employee Times from External Time Recording inbound process agent 308 to update the Employee Time master data object 150.

The Employee Time Confirmation View On Project business object 152 is a view on a project, adapted for the confirmation of Employee Time master data objects 150. In this example, the Project Processing process component 304 sends an update to a Maintain Employee Time Confirmation View On Project operation 310 that is included in a Project Task Confirmation In interface 312. The Employee Time Confirmation View On Project operation 310 maintains the Employee Time Confirmation View On Project business object 152 based on changes of the object Project in the Project Processing process component 304. As shown, the Employee Time Confirmation View On Project operation 310 triggers a Maintain Employee Time Confirmation View on Project inbound process agent 314 to update the Employee Time Confirmation View On Project business object 152.

The Time and Labor Management process component 106 also includes an Employee Time Agreement master data object 148 that contains basic time management regulations for an employee or the Work Agreement master data object 112 (e.g., positive vs. negative time management).

The Time and Labor Management process component 106 includes the Working Time Model master data object 134 and the Working Time Model Catalog master data object 136. The Working Time Model master data object 134 is a reusable module describing working time obligations or activities of employees. A Working Time Model master data object 134 can describe working time provisions such as attendance obligations, break times, or recurring activities. The Working Time Models master data objects 134 can be used as modules and used together, for example to represent daily and weekly work obligations or shift models. The Working Time Model Catalog master data object 136 is a structured directory of the available Working Time Models master data objects 134. The availability can be restricted to parts of the organization for individual parts of the catalog 136.

As shown, the Time and Labor Management process component 106 includes the Employee Time Account business object 138, the Employee Time Valuation business object 140, the Employee Time Balance Adjustment business object 144, and the Employee Time Confirmation Worklist business object 146. The Employee Time Account business object 138 is a summary of valuated information in the Employee Time master data objects 150 and of periodic valuations administered by the Employee Time Valuation business object 140. (The Employee Time master data object 150 is a document concerning the planned and actual working times of an internal or external employee of the company.) Valuation results are recorded in the Employee Time Accounts business object 138 in the form of line items, which are the quantitative changes of the Employee Time Account business object 138. Examples of the Employee Time Accounts business object are leave accounts and overtime accounts. Usually, laws, working time provisions, and collective agreements decide which types of employee time accounts are required. Balances can be formed over a particular period for individual line items in an employee time account, such as the weekly overtime or the monthly flextime balance. The balances can be used to check limits on working times, monitor entitlements and deductions, compile statistics, and to fulfill obligations to record such data for the authorities and employees. The Employee Time Balance Adjustment business objects 144 provide the user with a means to directly adjust the balances of employee time accounts.

The Employee Time Valuation business object 140 represents a time management valuation for a period, such as a day or week, for an employee. The Employee Time Valuation business object 140 gives rise to the creation of account entries, messages or entries in the Employee Time Calendar business object 142. The Employee Time Valuation business object 140 is also responsible for the check on data completeness. It is assumed that instances of the Employee Time Valuation business object 140 will be created on a regular basis.

The Employee Time Balance Adjustment business object 144 is an instruction, entered manually, to change the balances in the Employee Time Account business objects 138. The Employee Time Balance Adjustment business object 144 can increase or reduce balances of one Employee Time Account business object 138, or it can transfer balances between various Employee Time Account business objects 138, such as a transfer of balances from an overtime account to a time-off account. When valuating the Employee Time Balance Adjustment business object 144, the system creates new line items in the Employee Time Account business objects 138.

The Employee Time Confirmation Worklist business object 146 is a set of tasks allowed or planned for a given employee without concrete chronological assignment that contains attributes which are relevant for confirmations. The Employee Time Confirmation Worklist business object 146 may serve as employee specific value help. The Employee Time Confirmation Worklist business object 146 is mostly determined by other applications such as project system, but also from recently recorded confirmations.

As shown in FIG. 3B, an Accounting process component 320, a Project Processing process component 304, and a Goods and Service Acknowledgement process component 322 are describe exemplary interactions of the architectural design of the Employee Time Calendar business object 142. The Employee Time Calendar business object 142 gives a calendar based overview of different time data (planned working time, absences and working time confirmations) of an employee and their positions (e.g. illness vs. vacation).

In the depicted example, an update in the Employee Time Calendar business object 142 triggers a Notify of Service Provision from Employee Time Calendar to Accounting outbound process agent 324, a Notify of Project Task Confirmation from Employee Time Calendar to Project Processing outbound process agent 326, or a Notify Goods and Service Acknowledgement outbound process agent 328. If the Notify of Service Provision from Employee Time Calendar to Accounting outbound process agent 324 is triggered, the Notify of Service Provision from Employee Time Calendar to Accounting outbound process agent 324 calls either a Notify of Service Provision operation 330 or a Notify of Service Provision Cancellation operation 332, both included in a Service Provision Accounting Out interface 334. The Notify of Service Provision operation 330 notifies the Accounting process component 320 of actual service provided and actual time spent on performing the service. The Notify of Service Provision Cancellation operation 332 notifies Accounting that a confirmation of a provided service has been cancelled.

If the Notify of Project Task Confirmation from Employee Time Calendar to Project Processing outbound process agent 326 is triggered, the Notify of Project Task Confirmation from Employee Time Calendar to Project Processing outbound process agent 326 calls a Notify of Project Task Confirmation operation 336 included in a Project Task Confirmation Out interface 338. The Notify of Project Task Confirmation operation 336 notifies the Project Processing process component 304 of a project task confirmation or a project task status change. This notification is sent when an active employee time with project relevant information is created, changed or cancelled.

If the Notify Goods and Service Acknowledgement outbound process agent 328 is triggered, the Notify Goods and Service Acknowledgement outbound process agent 328 calls a Notify of Goods and Service Acknowledgement Notification operation 340 or a Notify of Goods and Service Acknowledgement Cancellation operation 342, both included in an Internal Service Acknowledgement Out interface 344. The Notify of Goods and Service Acknowledgement Notification operation 340 notifies the Goods and Service Acknowledgement process component 322 of a service provided by an external employee. This notification is sent when an active employee time with Goods and Service Acknowledgement relevant information is created, changed or cancelled. The Notify of Goods and Service Acknowledgement Cancellation operation 342 notifies the Goods and Service Acknowledgement process component 322 of a cancellation of service provided by an external employee.

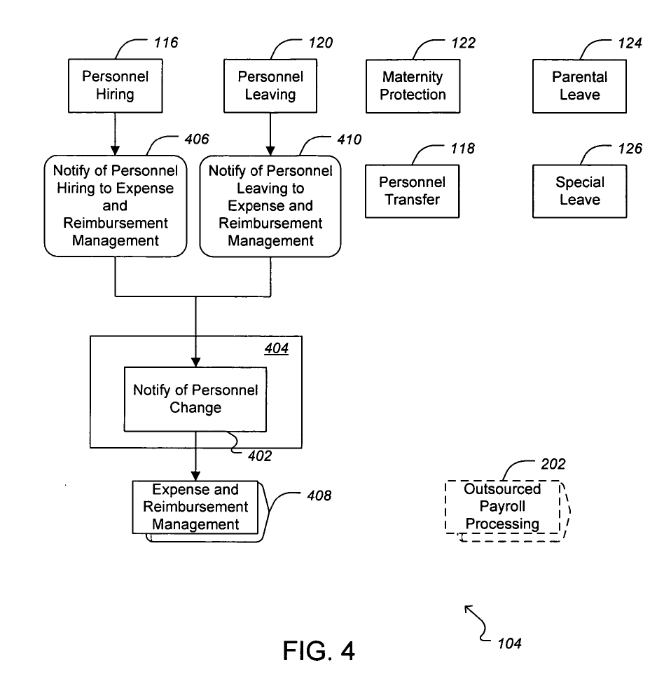

FIG. 4 is a block diagram of the Personnel Administration process component 104 (FIG. 1). The Outsourced Payroll Processing process component 202 is included to describe the Personnel Administration process component 104. The Personnel Administration process component 104 stores all employee information and includes all of the basic human capital management processes that companies require. As shown, the Personnel Administration process component 104 includes the Personnel Hiring business object 116 and the Personnel Leaving business object 124. The Personnel Hiring business object 116 is the admission of a person as an employee for the company. The Personnel Hiring business object 116 entails creating the Work Agreement master data object 112, creating the Employment master data object, and entering the employee's personal details such as name, address, and so on. The Personnel Leaving business object 124 represents the departure of an employee from the company. The departure results in changes to the Work Agreement master data object 112 and the Employment master data object 114.

As shown in FIG. 4, a Notify of Personnel Change operation 402 is included in a Personnel Administration Out interface 404. The Personnel Administration process component 104 uses the Notify of Personnel Change operation 402 for notification of a change in personnel. As one example, an update in the Personnel Hiring business object 116 may trigger a Notify of Personnel Hiring to Expense and Reimbursement Management outbound process agent 406 that calls the Notify of Personnel Change operation 404 to notify an Expense and Reimbursement Management process component 408 on hiring of personnel. As another example, an update in the Personnel Leaving business object 120 may trigger a Notify of Personnel Leaving to Expense and Reimbursement Management outbound process agent 410 that calls the Notify of Personnel Change operation 404 to notify the Expense and Reimbursement Management process component 408 on leaving of personnel.

Still referring to FIG. 4, the Personnel Administration process component 104 also includes other business objects and they are described below. The Maternity Protection business object 122 is a reusable module describing working time obligations or activities of employees. The Parental Leave business object 124 is an entitlement of an employee to time off work to care for a child as specified by the national laws and regulations. For example, an employee is protected from dismissal within the specified period. The protection results in time-related changes to the employment. The Personnel Transfer business object 118 is an organizational reassignment of an employee within the company. The reassignment results in changes to the details of the work agreement, for example, new tasks or a new cost center. The Special Leave business object 126 is an absence from work due to exceptional circumstances, either at the request of the employee (for example, sabbatical leave) or in accordance with country-specific legal regulations (for example, basic military service, alternative civilian service, jury duty). The absence results in time-related changes to the employment.

The subject matter described in this specification and all of the functional operations described in this specification can be implemented in digital electronic circuitry, or in computer software, firmware, or hardware, including the structural means disclosed in this specification and structural equivalents thereof, or in combinations of them. The subject matter described in this specification can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The subject matter described in this specification can be implemented in a computing system that includes a back-end component (e.g., a data server), a middleware component (e.g., an application server), or a front-end component (e.g., a client computer having a graphical user interface or a Web browser through which a user can interact with an implementation of the subject matter described herein), or any combination of such back-end, middleware, and front-end components. The components of the system can be interconnected by any form or medium of digital data communication, e.g. a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as an exemplification of preferred embodiments of the invention. Certain features that are described in this specification in the context of separate embodiments, may also be provided in combination in a single embodiment. Conversely, various features that are described in the context of a single embodiment may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter has been described in terms of particular variations, but other variations can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

What is claimed is:

1. A system comprising:
a computer system comprising one or more hardware platforms for executing computer software;
computer software deployed on the computer system, the computer software implementing a plurality of service operations, the service operations comprising:
a notify of employee compensation change operation operable to send a notification of a change in employee compensation;
a personnel time sheet information in operation operable to send a notification of a personal time sheet information;
a maintain employee time confirmation view on project operation operable to send a notification to maintain an employee time confirmation view on a project;
a notify of service provision operation operable to send a notification about a provision of service;
a notify of service provision cancellation operation operable to send a notification to cancel provision of a service;
a notify of project task confirmation operation operable to send a notification about a project task confirmation;
a notify of goods and service acknowledgement notification operation operable to send a notification about a notification of goods and service;
a notify of goods and service acknowledgement cancellation operation operable to send a notification to cancel goods and service; and
a notify of personnel change operation operable to send a notification about a change in personnel.

2. The system of claim 1, wherein the service operations are grouped into service interfaces, the service interfaces comprising:
a payroll out interface that includes the notify of employee compensation change operation;
a service provision accounting out interface that includes the notify of service provision and the notify of service provision cancellation operations;
a project task confirmation out interface that includes the notify of project task confirmation operation;
an internal service acknowledgement out interface that includes the notify of goods and service acknowledgement notification and the notify of goods and service acknowledgement cancellation operations;
a project task confirmation in interface that includes the maintain employee time confirmation view on project operation; and
a personnel administration out interface that includes the notify of personnel change operation.

3. The system of claim 1, wherein the computer software deployed on the computer system comprises:
a plurality of process components, each of the process components being a package of software deployed and executing on the computer system and implementing a respective and distinct business process, the plurality of process components including:
a compensation management process component used to plan and set up remuneration data for individual employees;
a time and labor management process component used to define and record working times; and
a personnel administration process component used to store employee information;
and wherein:
the compensation management process component implements the notify of employee compensation change operation,
the time and labor management process component implements the notify of service provision, the notify of service provision cancellation, the notify of project task confirmation, the notify of goods and service acknowledgement notification, and the notify of goods and service acknowledgement cancellation operations, and
the personnel administration process component implements the notify of personnel change operation.

4. The system of claim 3, wherein the computer software deployed on the computer system comprises:
a human capital deployment management unit to process human capital, the deployment unit being a package of software packaged together to be deployed on a single physical hardware platform;
wherein:
the human capital management deployment unit implements the notify of employee compensation change, the personnel time sheet information in, the maintain employee time confirmation view on project, the notify of service provision, the notify of service provision cancellation, the notify of project task confirmation, the notify of goods and service acknowledgement notification, the notify of goods and service acknowledgement cancellation, and the notify of personnel change service operations.

5. The system of claim 1, further comprising:
a repository of service descriptions, the repository including a standards-based description of each of the plurality of service operations.

6. A computer program product encoded on a tangible machine readable information carrier for implementing a plurality of services, the product comprising computer software operable to implement on a computer system service operations, the service operations comprising:
a notify of employee compensation change operation operable to send a notification of a change in employee compensation;
a personnel time sheet information in operation operable to send a notification of a personal time sheet information;
a maintain employee time confirmation view on project operation operable to send a notification to maintain an employee time confirmation view on a project;
a notify of service provision operation operable to send a notification about a provision of service;
a notify of service provision cancellation operation operable to send a notification to cancel provision of a service;
a notify of project task confirmation operation operable to send a notification about a project task confirmation;
a notify of goods and service acknowledgement notification operation operable to send a notification about a notification of goods and service;
a notify of goods and service acknowledgement cancellation operation operable to send a notification to cancel goods and service; and
a notify of personnel change operation operable to send a notification about a change in personnel.

7. The product of claim 6, wherein the computer software comprises:
a compensation management process component used to plan and set up remuneration data for individual employees;
a time and labor management process component used to define and record working times; and
a personnel administration process component used to store employee information;
and wherein:
the compensation management process component implements the notify of employee compensation change operation;
the time and labor management process component implements the notify of service provision, the notify of service provision cancellation, the notify of project task confirmation, the notify of goods and service acknowledgement notification, and the notify of goods and service acknowledgement cancellation operations, and
the personnel administration process component implements the notify of personnel change operation.

8. The product of claim 7, wherein the computer software comprises:
a human capital deployment management unit to process human capital, the deployment unit being a package of software packaged together to be deployed on a single physical hardware platform;
wherein:
the human capital management deployment unit includes an employment, a work agreement, an employee compensation agreement, a compensation structure, a compensation component type, a compensation component type catalog, a work time model, a working time model catalog, an employee time calendar, a employee time account, an employee time confirmation worklist, an employee time valuation, an employee time balance adjustment, an employee time data request, an employee time agreement, an employee time confirmation view on project, an employee time, a personnel hiring, a personnel transfer, a special leave, a parental leave, a personnel leaving, and a maternity protection business objects;
and wherein
the employment business object represents the relationship of one or more valid work agreements;
the work agreement business object represents a contract about work;
the employee compensation agreement business object represents an agreement between an employer and an employee on compensation relevant to the employee;
the compensation structure business object consists of compensation grades;
the compensation component type business object represents types that dividing up compensation components;
the compensation component type catalog business object is a structure directory of compensation component types;
the working time model business object describes working time obligations or activities of employees;
the working time model catalog business object is a structured directory of the available working time models;
the employee time calendar business object gives an calendar based overview of time data;
the employee time account business object is a summary of valuated employee times;
the employee time confirmation worklist business object is a set of tasks allowed or planned for an employee;
the employee time valuation business object represents a time management valuation for a period;
the employee time balance adjustment business object is an instruction to change the balances of an employee time account;
the employee time data request business object is a request of an employee for the approval of employee time data;
the employee time agreement business object contains basic time management regulations;
the employee time confirmation view on project business object is a view on a project for employee times confirmation;
the employee time business object includes documents concerning planned and recorded working times of an employee;
the personnel hiring business object represents the admission of a person as an employee;
the personnel transfer business object represents the organizational reassignments of an employee within a company;
the special leave business object represents absence from work due to exceptional circumstances;
the parental leave business object represents an entitlement of an employee to time off work to care for a child;
the personnel leave business object represents the departure of an employee from a company; and
the maternity protection business object represents the national laws and regulations protecting pregnant working women.

9. The product of claim 7, wherein:
each of the plurality of process components is assigned to no more than one deployment unit among multiple deployment units, and each deployment unit is deployable on a separate computer hardware platform independent of every other deployment unit; and
all interaction between a process component in one deployment unit and any other process component in any other deployment unit takes place through the respective service operations of the two process components.

10. The product of claim 9 further comprising:
a human capital management deployment that includes the personnel administration process component, the time and labor management process component, and the compensation management process component.

11. The product of claim 9 comprising:
a human capital management deployment unit that implements the notify of employee compensation change, the personnel time sheet information in, the maintain employee time confirmation view on project, the notify of service provision, the notify of service provision cancellation, the notify of project task confirmation, the notify of goods and service acknowledgement notification, the notify of goods and service acknowledgement cancellation, and the notify of personnel change service operation.

12. The product of claim 7, wherein:
the compensation management process component includes an employee compensation agreement business object, a compensation structure business object, a compensation component type business object, and a compensation component type catalog business object, wherein:
the employee compensation agreement business object is a business object that is an agreement between an employer and an employee on compensation relevant to the employee;
the compensation structure business object is a business object that consists of compensation grades,
the compensation component type business object is a business object that represents types that dividing up compensation components;
the compensation component type catalog business object is a business object that is a structure directory of compensation component types;
the time and labor management process component includes a working time model business object, a working time model catalog business object, an employee time calendar business object, an employee time account business object, an employee time confirmation worklist business object, an employee time confirmation worklist business object, an employee time balance adjustment business object, an employee time data request business object, an employee time agreement business object contains, and an employee time confirmation view on project business object, wherein:
the working time model business object is a business object that describes working time obligations or activities of employees;
the working time model catalog business object is a business object that is a structured directory of the available working time models;
the employee time calendar business object is a business object that gives an calendar based overview of time data;
the employee time account business object is a business object that is a summary of valuated employee times;
the employee time confirmation worklist business object is a business object that is a set of tasks allowed or planned for an employee;
the employee time valuation business object is a business object that represents a time management valuation for a period;
the employee time balance adjustment is a business object that business object is an instruction to change the balances of an employee time account;
the employee time data request business object is a business object that is a request of an employee for the approval of employee time data;
the employee time agreement business object is a business object that contains basic time management regulations;
the employee time confirmation view on project business object is a business object that is a view on a project for employee times confirmation; and
the personnel administration process component includes a personnel hiring business object, a personnel transfer business object, a special leave business object represents, a parental leave business object, a personnel leave business object, a maternity protection business object, wherein:
the personnel hiring business object is a business object that represents the admission of a person as an employee;
the personnel transfer business object is a business object that represents the organizational reassignments of an employee within a company;
the special leave business object is a business object that represents absence from work due to exceptional circumstances;
the parental leave business object is a business object that represents an entitlement of an employee to time off work to care for a child;
the personnel leave business object is a business object that represents the departure of an employee from a company, and
the maternity protection business object is a business object that represents the national laws and regulations protecting pregnant working women.

13. The product of claim 6, wherein
each of the process components includes one or more business objects; and
none of the business objects of any one of the process components interacts directly with any of the business objects included in any of the other process components.

14. The product of claim 13, wherein the business objects comprise a business process object.

15. The product of claim 13, wherein:
none of the business objects included in any one of the process components is included in any of the other process components.

16. The product of claim 6, further comprising:
a plurality of process agents, each process agent being either an inbound process agent or an outbound process agent, an inbound process agent being operable to receive a message from an inbound operation, an outbound process agent being operable to cause an outbound operation to send a message, each process agent being associated with exactly one process component;
wherein:
the inbound process agents comprise a first inbound process agent operable to start the execution of step requested in a first inbound message by creating or updating one or more business object instances; and
the outbound process agents comprise a first asynchronous outbound process agent that is called after a business object that is associated with the first outbound process agent changes.

17. A method for providing services from a computer system having human capital management functionality, the method comprising:
providing services through the sending of messages, the messages including:
a notification of a change in employee compensation;
a notification of a personal time sheet information;
a notification to maintain an employee time conformation view on project;
a notification about a provision of service;
a notification to cancel provision of a service;
a notification about a project task confirmation;
a notification about a notification of goods and service;
a notification to cancel goods and service; and
a notification about a change in personnel.
